(19) United States
(12) Patent Application Publication
(10) Pub. No.: US 2011/0025190 A1
(43) Pub. Date: Feb. 3, 2011

(54) LUMINOUS DEVICE

(75) Inventor: Hendrik Johannes Boudewijn Jagt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/922,723

(22) PCT Filed: Mar. 18, 2009
(86) PCT No.: PCT/IB2009/051146

§ 371 Date: Sep. 15, 2010

(30) Foreign Application Priority Data
Mar. 21, 2008 (EP) 08153168.3

(51) Int. Cl. H01J 1/62; H01J 5/16

(52) U.S. Cl. 313/499; 313/113

(57) ABSTRACT

The present invention relates to the field of luminous devices, in particular to a luminous device (1) comprising a light transmissive element (2). The light transmissive element further comprises a semiconductor diode structure (3) for generating light, a reflecting section (22) for reflecting light from the diode structure (3) into the light transmissive element (2) and an output section (21) for outputting light from the diode structure (3). The luminous device (1) further comprises a reflecting structure (4), at least partially enclosing side surfaces of the light transmissive element (2), for reflecting light from the diode structure (3) towards the output section (21).

### FIELD OF THE INVENTION

The present invention relates to the field of semiconductor luminous devices, more particularly to a luminous device comprising a light transmissive element, which comprises a semiconductor diode structure for generating light.

### BACKGROUND OF THE INVENTION

Semiconductor diodes, such as light emitting diodes (LEDs), high power LEDs, organic light emitting diodes (OLEDs) and laser diodes, are known to be energy efficient and small light sources that have a small etendue (i.e. the product of emitting area with solid angle in which the light is emitted). This implies that these diodes emit light from a relatively small area into a limited angular range, such as a half sphere. By using semiconductor diodes small and efficient optical systems may be built. Such optical systems typically collimate/direct light for further processing as required by any specific application. Typical examples of applications are projection systems, automotive front lighting, camera LED flashlights and spot lights. For most of these applications a further reduction of the LED etendue is desirable for improved miniaturization of the design. However, merely reducing the size of the semiconductor diode by scaling down the entire semiconductor diode reduces the generated light flux. Efforts have been made to improve the light direction and position of a light emitting area, such as to increase the efficiency of a particular optical design. For instance, light emitted towards the edges of a device or backwards towards reflectors surrounding the semiconductor diode is usually difficult to use in collimating optics and increases the etendue of the semiconductor diode.

In U.S. Pat. No. 5,528,057, there is disclosed a luminous element comprising an optically reflective surface having oblique concentric surface portions (a reflecting lens layer) for condensing light, generated in a luminous area, towards an exit window of the element. The luminous element is configured such that a region of an active layer serves as the luminous area. Disadvantageously, the efficiency of the luminous element is poor.

### SUMMARY OF THE INVENTION

An object of the present invention is to alleviate the problems of prior art.

This object is met by the luminous device as set forth in the appended independent claim 1 and the lighting system as set forth in the appended independent claim 15. Specific embodiments are defined in the dependent claims.

According to an aspect of the invention, there is provided a luminous device comprising a light transmissive element (or light transmissive assembly), which comprises a semiconductor diode structure (or semiconductor diode) for generating light, a reflecting section for reflecting light from the diode into the light transmissive element and an output section for outputting light from the diode structure. Furthermore, the luminous device further comprises a reflecting structure, at least partially enclosing side surfaces of the light transmissive element, for reflecting light from the diode structure towards the output section.

According to another aspect of the present invention, there is provided a lighting system comprising the luminous device according to embodiments of the present invention.

An idea of the invention is to provide a luminous device with reduced etendue by reducing a light output section while maintaining the amount of light (or light flux) generated. The luminous device comprises a light emitting (or transmissive) element (or a light emitting assembly) and a reflecting structure, which at least partially encompasses the light emitting element, and at least one semiconductor diode structure (or semiconductor diode die). The surface or surfaces (where light may be emitted/extracted) of the light transmissive element is/are divided into at least two sections or areas (i.e. the surface or surfaces may be patterned) having different properties. At least one area has high extraction efficiency while at least one other area has high reflection efficiency (or low extraction efficiency). In other words, the reflecting section and/or the output section may be arranged at a top surface of the light emitting element and/or at one or more side surfaces of the light emitting element. The top surface may be arranged oppositely to a submount (onto which the semiconductor diode structure may be arranged) such that the light emitting element is located between the top surface thereof and the submount. The (at least one) section having high reflection efficiency is intended to reflect light from the semiconductor diode back into the light emitting element such that the light may be reflected towards the output section (either directly or via additional reflections at, for instance, the reflecting structure) and thereby contribute to light flux from the luminous device. The reflecting structure (enclosing the light transmissive element) also reflects light, either directly or via additional reflections at, for instance, the reflective section, such that the reflected light eventually may be emitted though the output section(s) (output surface).

Furthermore, the non-extracted light is recycled by optimizing low-loss conditions in the reflecting structures and the semiconductor diode structure (or semiconductor diode). Hence, the light bounces in the cavity until it hits the extraction area (or output section), where the light will be emitted. As a result, some of the total light flux may be lost, but the flux density (brightness) at the output section may be increased. According to the above, a luminous device, having a reduced etendue, has been obtained while keeping light flux of the device as high as possible. Advantageously, the light emitted through the defined output section is more easily used in applications and leads to smaller designs of any applied optical construction.

It may be noted that whether or not there will be a total flux loss depends on the construction of the device, especially the construction of the surrounding submount. A submount with low reflectivity would result in high light loss for light emitted to the submount by the edges of the light emitting element. Therefore, it is preferred to make use of a reflecting structure of high reflectivity, whereby flux density may be increased.

Furthermore, even though the total light flux emitted by the LED may decrease, the total useful light flux in an optical construction, such as a collimator, may increase as more light is emitted in directions that are most effectively used in the application. For example, a brightness increase of 10-15% near normal angles (0 degrees) to a top surface (i.e. the above mentioned surface that is divided into sections) of the light emitting element results in light gain in the collimator (the optical construction), while the light flux at high angles, e.g. 80 to 90 degrees is not efficiently used by the collimator.

Any references to “up”, “down”, “top”, “bottom”, “upper”, “lower”, “above”, “under”, etc. are in to be taken with reference to a plane parallel to the plane of the semiconductor diode structure and are merely used in order to increase clarity. It shall, hence, be noted that the luminous device may be tilted any particular angle, such that these references may need to be reinterpreted in relation to the actual position of the particular luminous device, presently being observed.

Further, it may be noted that side surfaces of the light transmissive element are generally perpendicular to a plane of the output section. However, other angular orientations may also be realized for any specific application. It is preferred that the semiconductor diode structure is of a top emitting type.

Moreover, the reflecting structure may comprise any suitable reflecting means, such as a reflecting layer, a reflecting coating, reflecting film or a reflector, such as a (dichroic) mirror, a scattering reflector, a metal reflector, a dichroic reflector or a combination thereof or the like.

The expression “semiconductor diode structure for generating light” shall be understood as comprising a laser diode, in particular a VCSEL (vertical cavity surface emitting laser), a light emitting diode (LED) or the like. It may be noted that a VCSEL will generally have collimated emission through a top surface. Hence, in general, a VCSEL will only emit light though the top surface and not though the side surfaces. However, when combining a VCSEL with a phosphor to convert UV or blue light to another color, light will be scattered and light will possibly emitted through the side surfaces.

It has been found that, in embodiments of the luminous device according to the present invention, the light generating region of the diode structure, preferably, is as large as possible. Moreover, it is preferred that the area of the output section (or sections) is less than the area of the top surface of the light transmissive structure (and less than the area of the light generating region(s) of the diode structure). Preferably, the ratio of the area of the reflective section (or sections) to the area of the output section (or sections) is relatively small, i.e. the output section (or sections) is (are) large compared to the reflective section (or sections). As the output section is smaller than the area where light is generated, the etendue is reduced and due to recycling by means of the reflecting structure, a brightness gain is achieved. In this manner, etendue of the luminous device is reduced, i.e. a large light flux is generated and emitted from an output section, which may constitute a portion of the top surface of the light emitting element (or a portion of the side surface of the light emitting element). Furthermore, in some embodiments it is preferred that the side surfaces are substantially completely enclosed by the reflecting structure.

In an embodiment of the luminous device according to the present invention, the reflecting section is provided with a material having a refractive index being less than the refractive index of the light transmissive element, whereby light may be reflected by total internal reflection. In other words, there is provided a transition from a first refractive index of the light transmissive element to a refractive index, being lower than mentioned first refractive index, of the material provided at the reflecting section. In this manner, a substantial portion of the light incident on the reflecting section will be reflected by total internal reflection. This occurs especially when the refractive index of the light transmissive element is high compared to the areas with high reflectivity (the reflective sections).

In another embodiment of the luminous device according to the present invention, the reflecting structure further encloses the reflecting section, i.e. reflecting means at the reflecting section may be provided by the reflecting structure at least partially enclosing the light transmissive element and the reflecting section of the light transmissive element. The (at least one) section with low (compared to the output section) extraction efficiency may also have low optical loss properties, such as to not substantially lose (absorb) the light incident on this section or these sections. Typically, the reflecting sections comprise a highly reflective coating (or layer) with a reflection coefficient close to 100%. For example, a diffusive scattering coating, a metallic mirror, a dichroic mirror or combinations thereof may be employed.

It shall be noted that, in other embodiments of the luminous device according to the invention, a reflecting section making use of a combination of the refractive index transition and a reflecting structure may be realized.

In further embodiments of the luminous device according to the present invention, the output section comprises a roughened area, such as a forward scattering area or a forward scattering layer/coating, micro-optical extraction structures, micro-prismatic pyramids or grooves, diffraction gratings, holographic grating structures, photonic crystals, quasi-photonic crystals or the like or a combination thereof. In this manner, the extraction efficiency of the luminous device may be increased.

In yet further embodiments of the luminous device according to the present invention, the light emitting element (or light transmissive assembly) further comprises a light guiding layer, disposed between the semiconductor diode and the output section. For example, the light guiding layer may comprise a phosphor material, a phosphor ceramic material, an LED substrate, transparent YAG, glass, sapphire, alumina or quartz, or a combination thereof. In case the light guiding layer comprises a phosphor material and a transparent layer (an LED substrate), the total thickness of the phosphor material and the transparent layer may be tuned to the thickness of the active light generating layer of the semiconductor diode. In this manner, the efficiency of the device may, in general, be increased provided that the light guiding layer is substantially non-lossy and non-absorbing.

In yet other embodiments of the luminous device according to the present invention, the output section is provided with a first phosphor (ceramic) material. In this manner, color content of light emitted from the luminous device may be controlled.

Furthermore, in still other embodiments of the luminous device according to the present invention, a phosphor (ceramic) material, provided at the output section, may be of a different type than a phosphor (ceramic) material comprised by the light guiding layer. For example, a luminous device comprising a semiconductor diode emitting blue light, a light guiding layer of a phosphor material, such as YAG:Ce (converting blue light to green, yellow and some red light), resulting in a white (i.e. a mixture of red, green and blue) light flux, and an output section comprising a red phosphor material may provide a warm white light emission. A portion of the blue light will be converted to red, yellow and green light in the white phosphor (thereby providing white light as a mixture of red, yellow, green and blue) and the red phosphor will increase the amount of red in the emitted light such that the emitted light will be perceived as warm white light (i.e. white light having a red component).

In still further embodiments of the luminous device according to the present invention, the light emitting element further comprises a second output section provided with a second phosphor (e.g. ceramic) material, being of a different type than the first phosphor (e.g. ceramic) material. In this manner, light of different colors from the output sections will mix in the far field. The mixture (color content) of light may be determined by the arrangement and number of output sections of specific colors (i.e. output sections provided with different phosphor materials). For example, when using a semiconductor diode emitting blue light, two output sections provided with red phosphor and one output section provided with green phosphor (and optionally some “empty” output sections) may provide warm white light emission in the far field.

Moreover, in some embodiments of the luminous device according to the present invention, the light emitting element comprises an array of output sections.

Additionally, in embodiments of the luminous device according to the present invention, the shape of the output section may be rectangular, triangular, polygonal, square, elliptical, circular, in the form of a cross or even a textual message or an image or a combination thereof.

In still other embodiments of the luminous device according to the present invention, the output section is provided with a collimator, a light extraction dome or a combination thereof. LEDs are usually equipped with a half-sphere dome to extract more light form the device, reducing total internal reflection losses at the light emitting surface, compared to a direct transmission from a flat light emitting surface to air. In this manner, light emission of the luminous device may be controlled as required by any specific application. For example, an LED used as a flash may be combined with collimator optics to squeeze the emitted light of a half-sphere solid angle to a collimated beam of +/−20 degrees. Similar constructions may be used for projection display applications.

Further features of, and advantages with, the present invention will become apparent when studying the appended claims and the following description. Those skilled in the art realize that different features of the present invention may be combined to create embodiments other than those described in the following, without departing from the scope of the present invention.

### BRIEF DESCRIPTION OF THE DRAWINGS

The various aspects of the invention, including its particular features and advantages, will be readily understood from the following detailed description and the accompanying drawings, in which:

FIG. 1 shows a cross-sectional, side view of a luminous device according to an embodiment of the present invention,

FIG. 2 shows a cross-sectional, side view of the luminous device according to FIG. 1, wherein the light transmissive element further comprises an LED substrate,

FIG. 3 shows a cross-sectional, side view of the luminous device according to FIG. 2, wherein the output section is provided with a phosphor material,

FIG. 4 shows a cross-sectional, side view of a luminous device according to another embodiment of the present invention, wherein the light transmissive element further comprises a white phosphor material and the output section is provided with a red phosphor material,

FIG. 5 shows a cross-sectional, side view of a luminous device according to still another embodiment of the present invention, wherein the luminous device is provided with a dome for guiding the light from the output section,

FIG. 6 shows a cross-sectional, perspective view of a luminous device, wherein the light transmissive element comprises a phosphor material,

FIG. 7 shows a cross-sectional, perspective view of another embodiment of the luminous device according FIG. 6,

FIG. 8 shows a cross-sectional, perspective view of a further embodiment of the luminous device in FIG. 6, wherein the luminous device is provided with a plurality of output sections, each output section being in the form of a square,

FIG. 9 shows a cross-sectional, perspective view of another embodiment of the luminous device in FIG. 8, wherein each output section is in the form of a circle,

FIG. 10 shows a cross-sectional, perspective view of a further embodiment of the luminous device according to the present invention, wherein in the light transmissive element further comprises an LED substrate and a first set of output sections are provided with a phosphor material of a first type, a second set of output sections are provided with a phosphor material of a second type and a third set of output sections are provided with a phosphor material of a third type,

FIG. 11 shows a cross-sectional, side view of yet another embodiment of the luminous device according to the present invention, wherein each one of a plurality of output sections is provided with a respective extraction dome,

FIG. 12 shows a cross-sectional, side view of still another embodiment of the luminous device according to the present invention, wherein each one of a plurality of output sections is provided with a respective collimator, and

FIG. 13 shows a cross-sectional, side view of a still further embodiment of the luminous device according to the present invention, wherein a plurality of output sections is provided with roughened extractions areas.

FIG. 14 shows a cross-sectional, side view of yet a further embodiment of the luminous device according to the present invention, wherein output sections and reflecting sections are arranged at the side surfaces of the light emitting element.

### DETAILED DESCRIPTION OF EMBODIMENTS

Throughout the following description similar reference numerals have been used to denote similar elements, parts, items or features, when applicable.

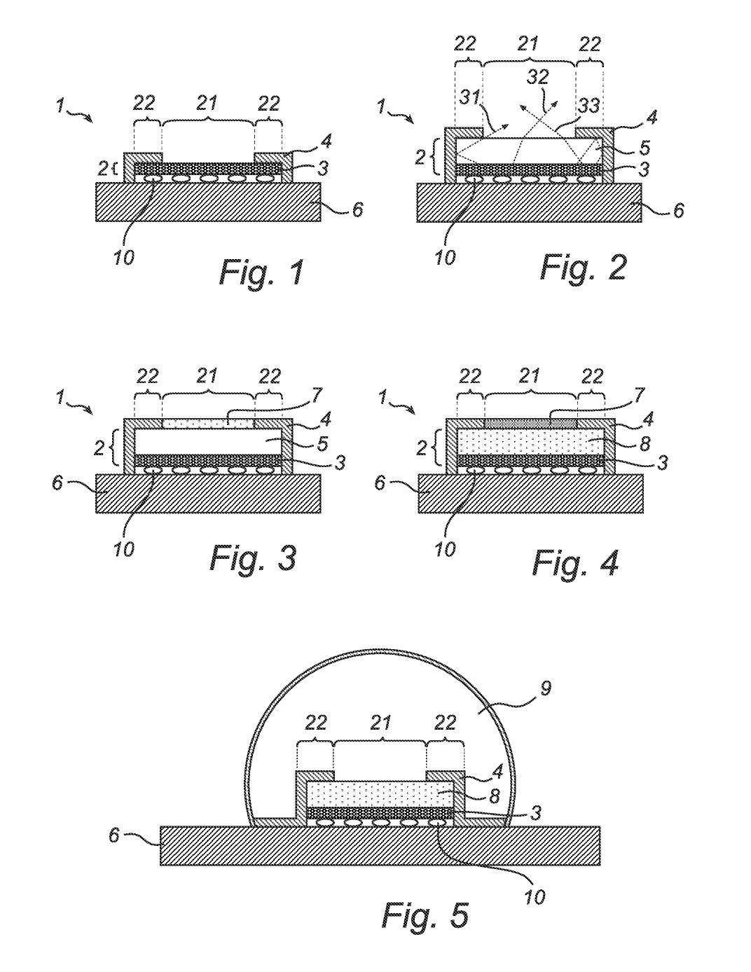

In FIG. 1, there is shown a cross-sectional, side view of a luminous device according to an embodiment of the present invention. The luminous device 1 comprises a light transmissive element 2, which in this case is an LED die or LED chip 3, and a reflector 4 (a reflecting structure). The luminous device is mounted on a submount 6. As can be seen from FIG. 1, the reflector 4 is arranged to partially cover the upper surface of the LED die 3. As a result, the upper (according to FIG. 1) surface of the LED die 3 (LED layer or semiconductor diode structure) comprises an output section 21 for outputting light from the LED die 3 and a reflecting section 22 for reflecting light from the LED die 3 back into the LED die. The reflected light will be reflected once again and will eventually hit the output section 21, thereby contributing to the light flux from the luminous device. The size of the LED die is typically 1 mm×1 mm and the thickness thereof is typically 1 to 10 μm. The size of the luminous device 1 may be much larger. The reflector may be a metal reflector (having a typical thickness of 100 nm), a dichroic reflector (typical thickness 1-5 μm), a scattering reflector (typical thickness 5-200 μm, usually about 50 μm). In some embodiments, it may be preferred to combine a metal (or dichroic) reflector at the top surface with a scattering reflector at the side surfaces.

Furthermore, in FIG. 1, there is shown a number of ellipsoidal (or in cross-section elliptical) elements (or simply beads). These beads indicate the positive and negative electrical connections for applying a drive signal (a voltage or current) across the semiconductor diode 3. The LED die 3 is of TFFC (thin film flip chip) type, in which the LED die 3 forms a thin layer (an original carrier substrate has been removed) and the LED die 3 is mounted upside down (‘flipped’) on the submount 6. Both positive and negative contacts are connected from the same side of the LED die 3. Inside the LED chip 3 there are some electrical vias (not shown) to connect the bottom contact to the top LED electrode (not shown). The beads schematically depict the contacting of the LED die 3. The LED die 3 itself is not shown in detail. As is well known, an LED die 3 consists of several semi-conducting layers comprising a p,n-junction and contacts for driving of the LED die 3. Also the rear of the LED die 3 is usually covered with a high reflective layer, such as a metal reflector, which simultaneously may be a rear electrodes of the die. In this way, the light generated in the LED is forced to be emitted in, typically, a half-sphere in the upward direction. The LED die 3, shown in FIG. 1, is contacted from the bottom via a submount. There are, however, other connection technologies that make a more direct electrical contact by soldering or welding processes between the rear of the LED die 3 and connection pads of the submount 6. A direct contact without beads between LED die 3 and the submount 6 may also be realized. Accordingly, substantially the entire LED die 3 will be activated and create an elongated light generating active region that extends over essentially the complete LED die 3. A common top contacting construction may also be used. In such a top contacting construction, a wire bond is used to contact the top electrode of the LED from a contact area on the submount. This is less preferred due to optical and constructive considerations.

Furthermore, electrodes of the LED die 3 may be divided into segmented regions that either emit light simultaneously or may be individually addressed, depending on the electrical connections to the segments. As such, the LED die 3 may be split into various regions that may be separately electrically controlled. The segmented areas may be made next to each other on the same LED substrate and may share a common electrode, either the top or bottom electrode. However, the segments may also consist of separate dies constructed in close proximity to each other, in which the LED die is of a multi-die type. For example, the LED die may consist of areas emitting red, green or blue. Similar considerations hold for other light emitting semiconductor diodes, such as solid-state lasers.

Now referring to FIG. 2, a cross-sectional, side view of the luminous device according to FIG. 1 is illustrated. In FIG. 2, the light transmissive element 2 of the luminous device in FIG. 1 further comprises an LED substrate 5 (which typically has a thickness of 100-300 μm, preferably 100 μm). The LED substrate 5 is provided above the LED die 3. In the Figure, three light beams 31, 32, 33 are indicated. The first light beam 31 indicates that light may be incident on the output section 21 after being reflected by the reflector 4 at a side surface of the light transmissive element 2. The second light beam 32 demonstrates light directly incident on the output section 21. The last light beam 33 illustrates a beam 33 that has been reflected several times at the reflector 4 (both in the vicinity of the side surface of the light transmissive element 2 and at the reflecting section 22) before being extracted at the output section 21. It may be noted that it is equally feasible to use an LED die 3, which has been removed from a substrate. Instead, it may be bonded to a transparent tile onto which the reflector has been fixed, typically by glue bonding (adhesive layer not shown). A possible advantage may be that the LED die 3 and the transparent tile with the reflector may be produced separately.

In FIG. 2, the reflections (of light beams 31, 32 and 33) at the reflector 4 are shown as specular reflections, in which the angle of incidence and the angle of reflection are equal with respect to a normal direction. However, these reflections might also be diffuse reflections instead of specular reflections or a combination of partial specular reflections and partial diffuse reflections. This will depend on the type of reflector used, for instance, a metal such as aluminum or silver deposited on a smooth surface will be a specular reflector, whereas a metal deposited on rough surface will typically be only partially specular reflective and partially diffusely reflective in which the angles of reflection will deviate from the angle of incidence, in which the amount of deviation will depend on the amount of roughness present. Preferably, the reflector is a scattering (diffuse) reflector, such as white paint or a porous ceramic, whereby incident light is redirected to deviating angles such that light escapes through the output sections with a minimal number of reflection interactions. The LED substrate 5 or a separately attached transparent tile may also contain scattering centers, such as small pores, crystals, or small areas/particles of deviating index of refraction, to achieve redirection capability.

FIG. 3 shows a cross-sectional, side view of the luminous device according to FIG. 2. In this example, the output section 21 is provided with a phosphor material 7, preferably a phosphor ceramic material, e.g. by bonding the phosphor to the LED substrate or transparent tile (bond layer not shown). The color of the phosphor, such as red, green and blue, may be selected according to the requirements of the specific application. For some applications, it may be desirable to use several phosphor materials in combination, such as a green layer in combination with a red layer for the case when the light from the LED die is blue, e.g. in a stacked configuration. The combined phosphor, in a stacked configuration or laterally arranged at different output areas 21, mainly applies to FIG. 4 (see below), in which layer 8 may consist of several stacked phosphor layers (easiest to implement) or laterally arranged combined phosphors. The laterally arranged configuration may be combined with LED die (electrode) segmentation (as described above) to tune the color ratio of the light through the output areas. In FIG. 3, layer 7 may also contain a stack of phosphor layers or have a laterally arranged phosphors portions. In this manner, white light (as a mixture or red, green and blue light) may be realized. Advantageously, the thickness of the layers provided at the output section determines the color content of the emitted light.

In a further example of the luminous device in FIG. 3, the LED substrate 5 (or a phosphor element 8 as in FIG. 4) may extend beyond the area of the LED die (or light emitting solid state device) 3. An oversized substrate 5 on the LED die 3 is useful for facilitating bonding and positioning accuracy of the substrate to the LED area. The area of the phosphor layer 7 (which also may be present at the output section 21 in FIG. 1) is smaller than the area of the LED die 3. It is to be noted that the thickness of the phosphor layer must not necessarily be the same as the thickness of the reflecting structure 4. The phosphor layer 7 may be thinner or thicker. The reflector coating 4 (reflecting structure) may also cover the sides of the phosphor layer 7 and the output section may also be defined on the top of the phosphor layer (or the phosphor surface).

With reference to FIG. 4, there is shown a cross-sectional side view of a luminous device 1 according to another embodiment of the present invention. In this example, the luminous device 1 comprises light transmissive element 2, comprising a white phosphor ceramic material 8, having a thickness of 50 to 400 μm, preferably 120 μm. Furthermore, the output section 21 of the luminous device 1 is provided with a red phosphor ceramic material 7. The LED die 3 is capable of emitting blue light. In this configuration, the light emitted from the LED die 3, typically blue light, is converted to red and green light in the white phosphor ceramic material 8 (some of the blue light from the LED die 3 is not converted at all). Before the light exits the luminous device 1, the red phosphor ceramic material 7 converts some of the light passing therethrough to red light, typically of longer wavelengths, thereby increasing the portion of deep red light in the emitted light. As a consequence, the emission from the luminous device is perceived as warm white light. The phosphor layer 7 may deviate in thickness from the thickness of the reflector, being either thinner or thicker.

FIG. 4 may also depict a configuration, in which the phosphor layer 8 converts blue light to e.g. green, amber or red light. In such a configuration, layer 7 represents a blue absorbing layer, which allows passage of the converted green, amber or red light. In this manner, any small amount of unconverted blue light is filtered out or absorbed to provide an increase in color purity to the colored green, amber or red emission. In a further example of a luminous device, layer 7 may represent a dichroic filter that reflects blue light and transmits the converted light. In this case, the blue light has a reasonable chance of being absorbed by the phosphor layer 8 and emitted as converted light, thereby recycling the blue light.

It is to be noted that, in the Figures, in which the exemplifying luminous device comprises a phosphor (ceramic) material arranged on (or above) the LED die 3, a thin (a few microns thick) bond or adhesive layer, such as a silicone, has been omitted for clarity. In cases where the phosphor layers consists of phosphor particles dispersed in a binder, such as a silicone, such a bond layer is typically not needed.

In FIG. 5, there is shown a cross-sectional, side view of a luminous device according to still another embodiment of the present invention. This exemplifying luminous device 1 comprises a dome 9 for increasing the efficiency of light extraction at the output section. The dome is, typically, a silicone dome. Usually the outside is a hard silicone and the inside of the dome is a silicone gel. The dome has the effect of frustrating total internal reflection at the extraction surface on the phosphor (due to reduction of difference in refractive index at the output section 21 as compared to without the dome 9). The subsequent transition from the dome to air occurs at the curved, round dome surface and occurs therefore more or less at angles close the normal of this interface, resulting in minimal light reflection losses, thereby maximizing the extraction efficiency. As the extraction area (the output section 21) of the phosphor material 8 is smaller than usual, the dome 9 may be smaller in size compared to a conventional LED. A hole (an output section 21) in the reflector 4 may, however, also be provided with a collimator in order to achieve a collimated light emission from the luminous device. Moreover, the reflecting layer 4 covers a portion of the submount 6. In this manner, any reflected light from the dome exit that may fall back between the edge of the dome (where it connects to the submount) and the light transmissive element in the center of the dome will be reflected with higher efficiency (than without the reflector portion at the submount 6) as the reflector will have a higher reflectivity than the submount.

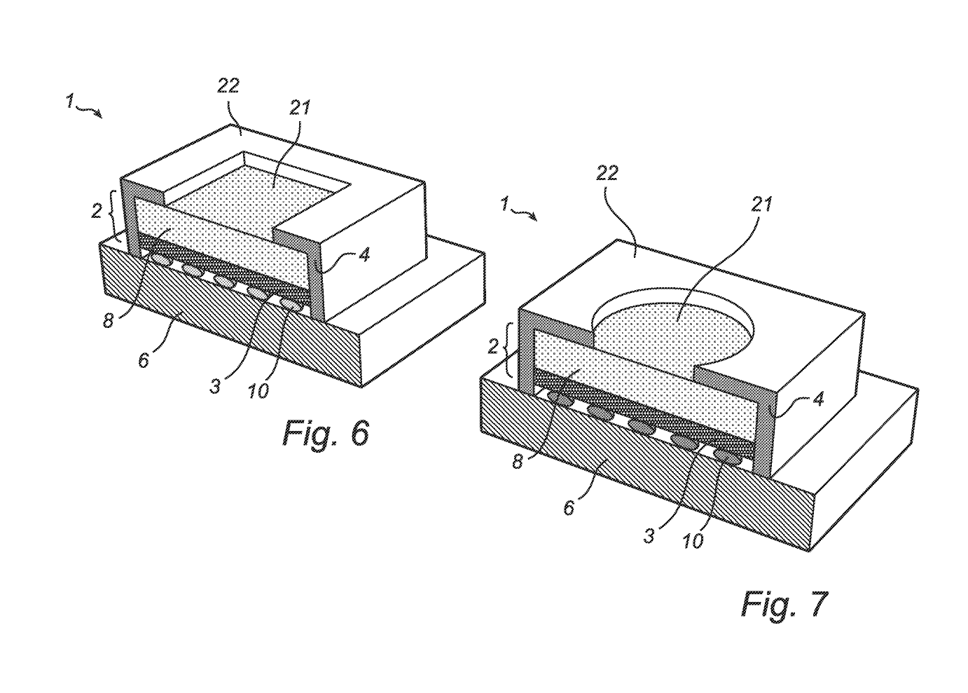

Now referring to FIG. 6, there is shown a cross-sectional, perspective view of a luminous device 1. In this example, the light transmissive element 2 comprises a phosphor material 8. A reflector 4 is applied on top of the layer of phosphor material 8. A hole in the reflector (output section 21) of square shape is formed for emission of light from the LED die 3. A squared optical body (light guiding layer), such as a squared glass tile extending beyond the reflector surface 22, may be present at the output area 21 in order to extract more light from the device by reducing total internal reflection at the output area and providing light extraction through the top and side surfaces of the glass tile.

FIG. 7 shows a cross-sectional, perspective view of another embodiment of the luminous device 1 according FIG. 6. In this example, the shape of the output section 21 is circular. This may be particularly appealing, since the circular output section 21 converts a typical square-shaped emission from a conventional LED (or luminous device) into a circular, angular symmetrical, round light beam. Advantageously, the angular symmetrical light beam may be use in combination with extraction domes or circular collimator optics. It shall, however, be noted that the shape of the output section 21 may be circular, square, triangular, rectangular, elliptical, cross-shaped or even contain textual messages or images/logos, etc.

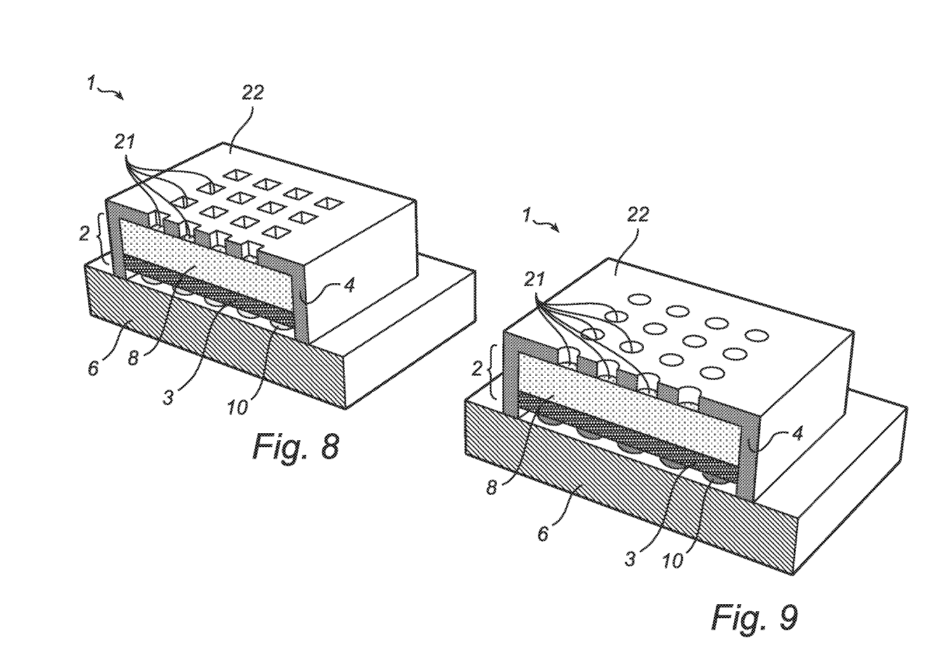

A further embodiment of the luminous device in FIG. 6 is illustrated in FIG. 8, which shows a cross-sectional, perspective view thereof. As may be seen in the Figure, the reflector 4 is provided with a plurality of holes or output sections 21. The output sections 21 are arranged in a matrix, but it shall be understood that the output sections may be arranged (patterned) in many other ways, such as line structures or crossed lines structures. This patterning freedom allows for control of the ratio of output area to reflecting area, whereby the extraction efficiency is influenced. In addition, it enables the possibility to make output areas and reflector areas with different sizes and shapes that still yield a similar ratio of output area to reflecting area. In this manner, the uniformity of total extraction over the device area or the extraction position on the device area may be controlled. Furthermore, the pattern of the extraction area may match a pattern of additional optical elements, such as domes, lenses, collimators, color filters, absorbing filters, dichroic filters.

In FIG. 9, there is demonstrated a cross-sectional, perspective view of another embodiment of the luminous device in FIG. 8. Here, the output sections 21 are shaped as circular holes in the reflector 4. Again, circular output sections may be particularly useful in combination with circular optics, such as domes or circular collimators.

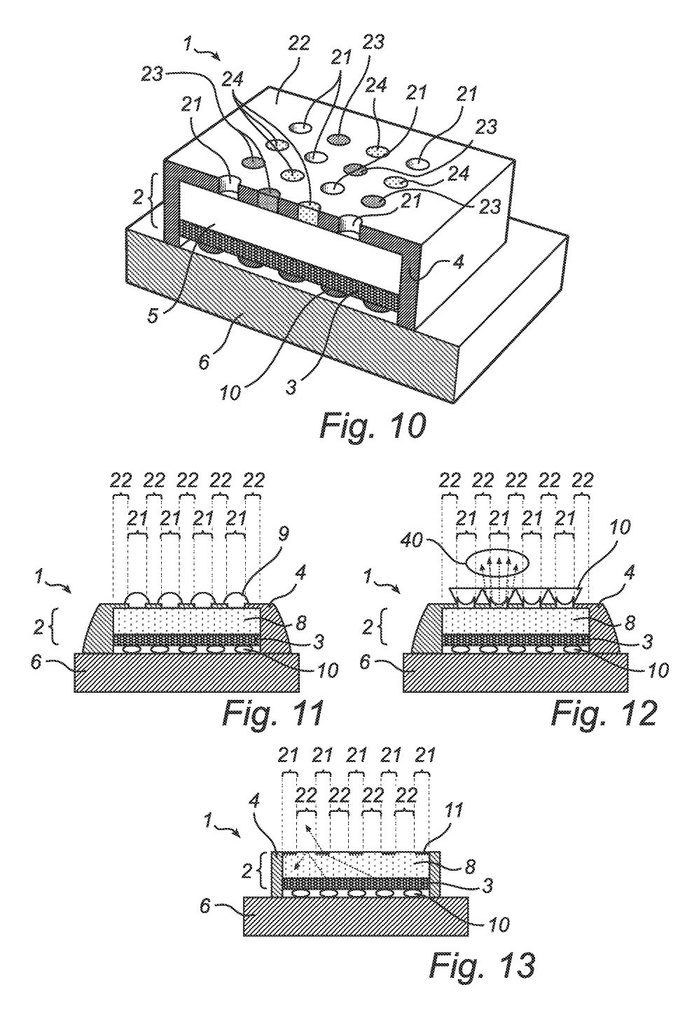

FIG. 10 shows a cross-sectional, perspective view of a further embodiment of the luminous device according to the present invention. In this example, the light transmissive element 2 further comprises an LED substrate 5 and a first set of output sections 21 are left empty or filled up with a transparent material, a second set of output sections 22 are provided with a phosphor material of a first type, such as red phosphors, and a third set of output sections 23 are provided with a phosphor material of a third type, such as green phosphors. The LED die 3 is capable of emitting blue light. In this manner, mixing of red, green and blue light in order to obtain white light may be realized. The color content of the far field pattern (light at a distance from the luminous device) is determined by the proportions of empty, red and green output sections. Of course, similarly, a UV emitting semiconductor device may be used. In such a device, the empty/transparent regions are filled with a UV absorbing-blue emitting phosphor. The combination of suitable blue, green and red phosphor provides white light.

Moreover, in FIG. 11, there is illustrated a cross-sectional, side view of yet another embodiment of the luminous device 1 according to the present invention. Each of a plurality of output sections 21 is provided with a respective extraction dome 9. In this manner, the extraction efficiency of the luminous device is increased, since the amount of light being totally internally reflected is reduced. In this example, the light transmissive element 2 comprises a phosphor (ceramic) material 8. The phosphor material may, however, be replaced by an LED substrate or a transparent piece of glass or the like. The transparent material may contain scattering centers to make the light more diffusive.

Now with reference to FIG. 12, there is shown a cross-sectional side view of still another embodiment of the luminous device 1 according to the present invention. In this example, a plurality of output sections 21 is provided with collimators, preferably one collimator for each output section 21 as shown in FIG. 12. A plurality of beams 40 emitted from an output section 21 indicates that the beams are collimated. However, the beams may diverge slightly from each other.

The array patterns of output sections (as shown in FIG. 8-13) subdivide the luminous device 1 into virtual light sources with reduced dimensions. These light sources may each have their own extraction dome to enhance the extraction efficiency as shown in FIGS. 5 and 11. Additionally, these virtual light sources may be combined with collimator array optics in order to achieve a collimated light flux array as shown in FIG. 12. It may be advantageous to use collimators at some virtual light sources and domes at some other virtual light sources, e.g. to combine a large angular distribution from the dome areas with a small angular distribution from the collimator areas. Also, the output areas 21 in FIGS. 11 and 12 may be covered with phosphor materials, similarly to FIG. 10.

Referring to FIG. 13, there is shown a cross-sectional side view of a still further embodiment of the luminous device 1 according to the present invention. In this example, a plurality of output sections 21 are provided with roughened extractions areas, such as forward scattering areas, micro-optical extraction structures, micro-prismatic pyramids or grooves, diffraction gratings, holographic grating structures and (quasi) photonic crystals. The reflecting areas 22 have reduced extraction efficiency, since a major portion of the light incident on these sections will be totally internally reflected. The light will be totally internally reflected, because the angle of a major portion of the incident light exceeds the critical angle. An additional reflector, either in optical contact or without optical contact (such as with a thin air gap in between the reflector and an optical body or light guiding layer 8) may be added to the areas with reduced extraction efficiency to further reduce their extraction efficiency and redirect light to be recycled and re-emitted through the areas with high extraction efficiency. Optical body (light guiding layer) 8 may be a phosphor material or an LED substrate or any other optical element that is non-absorbing to the incident light.

The roughened areas may be applied to some or all of the output sections 21. It shall be noted that these surface roughening structures may be employed in combination with any of the embodiments described herein. Explicitly, these surface roughening structures may be combined with dome structure(s) or collimator structure(s), similar to FIGS. 5, 11 and 12.

In all of the embodiments above, the sides of the LED die, the LED substrate, the optical body (the light guiding layer), such as the LED substrate or the phosphor materials are covered with the reflector. This is preferred for efficiency reasons. However, these sides need not to be covered, or may be covered only partially. The output sections may be present at the side areas as well, in addition to output section at the top surface of the device, or in replacement of the output sections at the top surface (which in that case will comprise of a uniform reflecting layer).

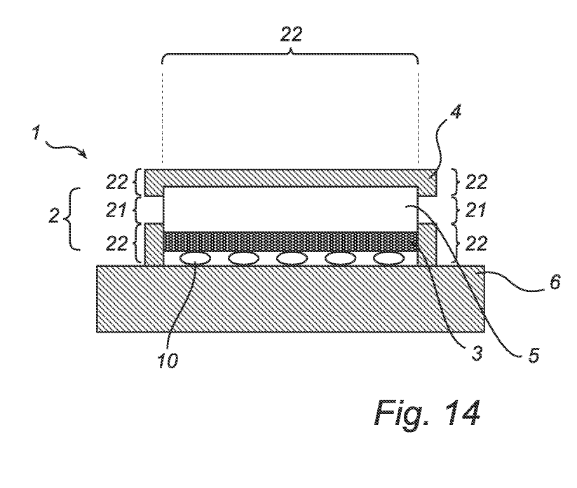

Now with reference to FIG. 14, there is shown an example of a luminous device 1 comprising light emitting element 2, which comprises an LED substrate 5 and an LED die 3. The light emitting element 2 comprises at output sections 21 and reflecting sections 22 that are located at the side surfaces of the light emitting element 2. Further, the luminous device comprises a reflector 4. In other examples of the luminous device 1 according to FIG. 14, the output sections 21 and reflecting sections 22 at the top surface may be omitted.

It is to be noted that in the Figures (except for FIGS. 11 and 12) the reflector 4 at the sides has been draw with straight lines. In practice, the shape of side of the reflector 4 may be slightly curved, either outwardly as in FIGS. 11 and 12 or inwardly (concave, not shown). A concave curvature may even be more likely, when using the coating techniques mentioned further below.

In a further example (not shown), a laser diode is used as the semiconductor diode structure (denoted 3 in the Figures). Preferably, a VCSEL (vertical cavity surface emitting laser) is employed. Such a laser diode emits light through a top surface thereof, similarly to the manner in which light is emitted from an LED. Typically, the laser diode has a wavelength of 450 nm (blue light). Further, such a luminous device, comprising a VCSEL, further comprises a phosphor material, such as YAG:Ce. YAG:Ce is capable of converting blue light to yellow light, mixing to white. Other phosphors may also be used such as to convert blue light to, for example, green, amber or red. The light beam from the laser diode is typically scattered in the phosphor (e.g. by pores or other scattering centers in the phosphor layer) in order to a leak (output) light directly from the luminous device, thereby the laser light is no longer collimated. If the phosphor material is substantially transparent some of the original collimated light may retain its collimation and polarization and may be transmitted through the output sections. The converted light typically will be isotropically emitted and therefore not contain a significant degree of collimation. The light beam may, in other examples, be directed towards the reflecting top surface (or the reflecting section denoted 22 in the Figures) and not directly towards the output section. The scattering reflector (i.e. the reflector 4 in the Figures) backscatters any blue or UV laser light that is not converted by the phosphor and redistributes the laser light, thereby collimation and polarization is lost. However, conversion of the blue light to a desired color or mix of blue with converted color, e.g. to white, is obtained. If a transparent body is used, part of the laser light will be directly emitted through the output section providing a patterned laser output. The collimation might be retained or lost depending on the optical structure present at the output area, of which examples have been mentioned above. The laser light not directed through the output areas will be recycled to achieve a higher efficiency. If a specular reflector is used, the collimation and polarization may be (partly) conserved. If a more diffusive reflector is used, the collimation, coherence and polarization will be lost to a higher extent.

In the above described examples of the luminous device a blue high-power LED (denoted 3 in the Figures) of the InGaN (Indium Gallium Nitride) type may be used. Such LEDs are grown in a complex layer stack on a suitable substrate in which the atomic packing distances of the substrate should sufficiently match that to the grown LED materials (as is well know in the art). Such a substrate may be SiC, preferably sapphire (Al₂O₃, n=1.77). The substrate may be several hundreds microns thick, typically 100 μm. There are known techniques for removing the substrate with e.g. laser release processes, freeing the thin LED layers (e.g. a few to 10 microns thick) from the substrate. On the thin LED layer a phosphor layer may be deposited, typically by bonding (bonding layers have been described above). For example, a ceramic phosphor component (e.g. a 1×1 mm and 120 μm thick ceramic tile) may be bonded to a 1×1 mm LED layer (or LED die). However, conventional phosphor materials, comprising phosphor particles of a few micron size embedded in a polymeric resin, may also be directly deposited on the LED chip (or LED layer).

In a further example of the luminous device according to the invention, the reflectors (denoted 4 in the Figures), applied adjacent the output section (or output sections), have a reflectivity close to 100%. A type of reflector coating that may realize this in an acceptable coating thickness is described in the European Patent Application 07122839.9. This coating consists of a hybrid material system that combines a high index phase with a low index phase of appropriate dimension such as to substantially backscatter the incident light. A preferably material system that may withstand the high light flux densities and thermal load close to the LED active area is based on a sol-gel derived binder system, such as silicate or methyl silicate or the like, filled with high index particles, typically TiO₂ of 100 to 1000 nm diameter, with a reflector thickness in the range of 2 to 1000 μm, preferably 20 to 50 μm. Alternatively, a reflector in the form of a metal layer (as mentioned above), such as a silver coating, may be used. However, it may be difficult to achieve a high reflectivity with such a metal layer and at the same time protect the metal from corrosion. Again as mentioned above, a dichroic reflector may be used. Such a dichroic reflector may have a very high reflectivity (up to 98% or more), but in a general case such a reflector may have a reduced performance for larger incident angles. It shall be understood that combinations of different reflector types may be applied, such as a dichroic coating in front of a metal layer.

Furthermore, the output sections (denoted 21 in the Figures) may be generated in a number of manners. In case of a white reflector coating, such as a TiO₂ filled sol-gel coating, the hole patterns (i.e. the output sections 21) may be generated by means of embossing during the wet or gelled phase of the coating. Alternatively or additionally, the hole pattern may be realized by dewetting on a hydrophobic pattern deposited at the hole areas (or the output sections), which may be applied by micro-contact printing, or other printing techniques.

Further techniques for generating the hole pattern (i.e. the output sections in the reflecting structure, when covering the top surface of the light transmissive element) includes direct printing, such as screen-printing or inkjet-printing, lithographic etching methods or laser ablation. Previous mentioned metal or dichroic patterning may be realized using deposition through masks, lithographic etching, reactive ion etching or laser ablation.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A luminous device (1), comprising a light transmissive element (2), which comprises a semiconductor diode structure (3) for generating light, a reflecting section (22) for reflecting light from the diode structure (3) into the light transmissive element (2) and an output section (21) for outputting light from the diode structure (3), wherein the device (1) further comprises a reflecting structure (4), at least partially enclosing side surfaces of the light transmissive element (2), for reflecting light from the diode structure (3) towards the output section (21), the area of the output section being less than the area of the diode structure.

2. The device (1) according to claim 1, wherein the reflecting structure (4) further encloses the reflecting section (22).

3. The device (1) according to claim 1, wherein the reflecting section (22) is provided with a material having a refractive index being less than the refractive index of the light transmissive element (2), whereby a portion of the light, generated in the semiconductor diode structure, is reflected by total internal reflection.

4. The device (1) according to claim 1 wherein the output section (21) comprises a roughened area.

5. The device (1) according to claim 4, wherein the roughened area comprises a forward scattering area, a micro-optical extraction structure, a micro-prismatic pyramid or groove, a diffraction grating, a holographic grating structure, a photonic crystal, a quasi-photonic crystal or a combination thereof.

6. The device (1) according to claim 1, wherein the light emitting element (2) further comprises a light guiding layer (5, 8), disposed between the diode structure (3) and the output section (21).

7. The device (1) according to claim 1, wherein the light guiding layer (5, 8) comprises a phosphor material, a phosphor ceramic material, an LED substrate, transparent YAG, glass, sapphire, quartz or a combination thereof.

8. The device (1) according to claim 1 wherein the output section (21) is provided with a first phosphor material (7), preferably a first phosphor ceramic material.

9. The device (1) according to claim 8, wherein the phosphor material (7), provided at the output section (21), is of a different type than a phosphor material (8), preferably phosphor ceramic material, comprised by the light guiding layer (5, 8).

10. The device (1) according to claim 8, wherein the light emitting element (2) further comprises a second output section (23) provided with a second phosphor material, being of a different type than the first phosphor material.

11. The device (1) according to claim 1, wherein the light emitting element (2) comprises an array of output sections (21).

12. The device (1) according to claim 1, wherein the shape of at least one output section (21) is rectangular, triangular, polygonal, square, elliptical, circular, in the form of a cross, or in the form of text/images/logos or a combination thereof.

13. The device (1) according to claim 1, wherein at least one output section (21) is provided with a collimator, a light extraction dome or a combination thereof.

14. The device (1) according to claim 1, wherein the diode structure (3) is a thin film flip chip type diode structure (3).

15. A lighting system comprising the device according to claim 1.
